(19) United States
(12) Patent Application Publication
(10) Pub. No.: US 2005/0009194 A1
(43) Pub. Date: Jan. 13, 2005

(54) Analytical method and device for determining metal concentration in liquid hydrocarbon matrices

(76) Inventors: Randall M. Franklin, Mechanicsville, VA (US); Joseph W. Roos, Mechanicsville, VA (US)

Correspondence Address: DENNIS H. RAINEAR, CHIEF PATENT COUNSEL, ETHYL CORPORATION, 330 SOUTH FOURTH STREET, RICHMOND, VA, 23219, US

(21) Appl. No.: 10/615,075

(22) Filed: Jul. 8, 2003

(51) Int. Cl. G01N 21/64

(52) U.S. Cl. 436/73; 436/166

(57) ABSTRACT

The invention provides a method and a system for detecting metal concentrations, such as manganese, in liquid hydrocarbon matrices.

### FIELD OF THE INVENTION

The present invention relates to a device and method for detecting metal concentration in various hydrocarbon matrices, such as for example, gasolines and distillate fuels. The device, also referred to as a kit, of this invention is able to detect and quantify levels of metals, such as manganese in the range between 0.5-50 milligrams/liter of metal in the hydrocarbonaceous matrices.

### BACKGROUND

Many metals find their way into combustible hydrocarbons, some by accident, and others intentionally. Monitoring the type and amount of these metals can be useful in enhancing performance and/or minimizing detriments in combustion devices.

Manganese in the form of, for example, methyl cyclopentadienyl manganese tricarbonyl (“MMT”) is added to combustible materials for several purposes, including use as an anti-knock agent for spark ignited engines. MMT® is a registered trademark of Ethyl Corporation for its methyl cyclopentadienyl manganese tricarbonyl fuel additive. Another use of MMT® is as an additive to distillate fuels as a smoke suppressant by catalyzing particulate carbon burnout both in compression ignition (diesel) engines and stationary burners. MMT® has been used as a fuel additive for many years and has recently received much attention for the significant improvements it can achieve in particulate emission reduction, smoke suppression, particulate trap regeneration, and scavenging of potential catalyst poisons. Fuel suppliers and customers are very interested in the effective treat rates and cost effectiveness of MMT® as a fuel additive, as well as verifying that a fuel has been properly additized.

A method for detecting and quantifying manganese in aqueous media is commercially available as “REFLECTOQUANT Manganese Test, distributed by EM SCIENCE, a division of EM Industries, Inc., Gibbstown, N.J. 08027. This strip is commercially optimized for photometrically determining manganese levels in aqueous media in the range of 0.5-45 mg/l Mn. As described in the public literature, however, this method cannot perform the same function in organic media.

Thus, a need has arisen for determining easily, quickly and inexpensively the presence and amount of metals, including manganese, in various hydrocarbon matrices, such as but not limited to fuels.

### SUMMARY OF THE EMBODIMENTS

An embodiment presented herein provides a device for determining metal levels in various hydrocarbon matrices, such as for example, gasolines and distillate fuels. In one embodiment, the metal is manganese.

By “hydrocarbon matrix” herein is meant any hydrocarbonaceous material, fluid, composition or mixture, containing organic chemicals. The hydrocarbon matrices herein can include for example but are not limited to fuels such as gasoline and petroleum distillate, diesel fuel, biodiesel fuel, kerosene, crude oil, refined oil, lubricants, including engine oils, transmission fluids, hydraulic oils, aviation fuels, cutting fluids, extracts from the above, distillate bottoms, fuel oil, and other hydrocarbonaceous matrices.

Another embodiment provides a method for determining metal levels in various hydrocarbon matrices, such as for example, gasolines and distillate fuels. In one embodiment, the metal is manganese.

Accordingly, in one example herein is provided a method for detecting the presence and amount of a metallic species in a hydrocarbon matrix, comprising (a) contacting a hydrocarbon matrix containing an organometallic compound with a calorimetric detection material comprising a calorimetric sensitizer chemical able to react with the metal of the organometallic compound; (b) causing a reaction between the metal from the organometallic compound and the calorimetric sensitizer chemical sufficient to form an organometallic complex, and (c) detecting the presence of the organometallic complex.

In another example is provided a detection system, device or kit useful in the determination of the amount of manganese in an organo manganese-containing hydrocarbon matrix. As an example, the detection system, device or kit for detecting the presence of metal in a hydrocarbon matrix can include a colorimetric detection material comprising at least one colorimetric sensitizer chemical able to react with a metal of an organometallic compound in the hydrocarbon matrix.

It is to be understood that both the foregoing general description and the following detailed description are exemplary and explanatory only and are intended to provide further explanation of the present invention, as claimed.

### DETAILED DESCRIPTION OF EMBODIMENTS

In an example of an embodiment provided herein a method for detecting the presence and amount of metal present as an organometallic compound such as organo manganese in a hydrocarbon matrix is provided that comprises 1) immersing or contacting a calorimetric or material in or with the organometallic-containing hydrocarbon matrix, herein the organometallic compound containing certain organic ligands that bind to the metal atoms, 2) subjecting the material to heat, chemical energy or ultra violet (UV) light, if necessary, to liberate the metal from the organic ligands and deposit the freed metal on or in the colorimetric detection material or within its structure, 3) if necessary to achieve colorimetric detection by a sensitizer, adding a sufficient amount (for example, a few drops) of dilute (for example 2% to 10%) basic solution, such as NaOH (Reagent No. 1), followed by adding a sufficient amount (such as a few drops) of aqueous dilute acid, such as acetic acid (for example 5% to 15%) (Reagent No. 2). In an embodiment, the two reagents achieve the oxidation of the metal sufficient for the metal to then react with a colorimetric sensitizer in or on the detection material to form an organometallic complex that is calorimetrically detected and quantified using for example the “Rqflex” electronic calorimeter detection unit, (also referred to herein as a “photometer”). The metal is in one example Mn (IV) and is, in one embodiment, calorimetrically quantified using a colorimetric photometer, such as the Merck-distributed electronic meter called “Rqflex.” When the treated detection material is inserted in or exposed to the photometer, the photometer translates the color intensity resulting from the organometallic complex to a concentration reading, which is then electronically displayed on the instrument.

By “calorimetric detection material” herein is meant any solid article such as a strip, tab, pad, membrane, filter, etc. or any liquid composition, solution, mixture, etc., wherein the material is able to, or contains a substance that is able to, calorimetrically detect or facilitate detection of the presence of an organometallic complex or the metal thereof.

By “dilute basic solution” herein is meant an aqueous basic solution of an alkali or alkaline earth metal salt, including for example NaOH, KOH, Ca(OH)₂, and Mg(OH)₂ or precursors, derivatives or mixtures thereof.

By “dilute acid” herein is meant an aqueous acid solution of a mineral acid or organic acid, such as HCI, acetic acid, etc.

In an embodiment herein, the colorimetric detection material is a strip, Reagent No. 1, Reagent No. 2, and “Rqflex” electronic colorimetric detection unit useful herein are all commercially available as a kit under the name of “REFLECTOQUANT Manganese Test”, distributed by EM SCIENCE, a division of EM Industries, Inc., Gibbstown, N.J. 08027. However, as supplied commercially the “REFLECTOQUANT Manganese Test” kit is optimized for detecting manganese in aqueous media and does not work for liquid hydrocarbon matrices. The current invention provides both a kit and a method to detect manganese in hydrocarbon media by introducing steps 1 and 2 into the procedure as outlined above.

The results validating certain embodiments of this invention are graphically summarized in FIG. 1. The data points labeled “Actual” correspond to the amount of manganese pipetted into each fuel (hydrocarbon matrix) as calculated to give the indicated concentrations. Each data point to the curve labeled “Invention” was the average of three determinations carried out by a method of this invention. As can be seen from the relationship between the two data sets, it is possible to generate a calibration curve for this embodiment of the invention method.

[image]

The present invention, in an embodiment, converts the organic manganese (such as but not limited to MMT) into an inorganic form (Mn II) and transports it from the organic phase on to an inorganic substrate or matrix on or in a colorimetric detection strip or material or into an inorganic composition such as an aqueous solution. Once adsorbed on the inorganic matrix of the detection strip or dispersed on the aqueous solution, the Mn (II) is oxidized to Mn (IV) by the base/acid reagents for forming the organometallic complex and subsequent detection and quantification as described above.

In contrast to the published aqueous method above, this method of this embodiment involves contacting the calorimetric detection material with or immersing it into the hydrocarbon matrix containing the metal such as manganese or iron to layer, adsorb or absorb an organic film on top of or within the inorganic detection material, strip, substrate or matrix. Subjecting this treated detection material to sufficient energy, such as UV radiation, to decompose the organic metallic compound (such as ferrocene and MMT) to inorganic iron or manganese, which adsorbs into or disperses in the inorganic detection material. Treatment with Reagent 1 followed by treatment with by Reagent 2 can oxidize the manganese (II) to manganese (IV) which then binds with the colorimetric indicator chemical in the inorganic detection material to form an organometallic complex. This complex can then be analyzed using a detection device, such as the Rqflex calorimetric electronic meter, to quantify the manganese concentration of the hydrocarbon matrix being analyzed.

The energy applied to decompose the organometallic compound can also be thermal (heat), chemical, sonic, or sunlight. In one example, the wavelength and intensity in joules/mole is designed to match the wavelength of absorption of the organometallic compound.

The method of an embodiment herein can be used to detect and quantify gasoline and diesel fuels treated with the manganese containing additive MMT, for either anti-knock purposes (gasolines) or for particulate emission lowering (distillate fuels). The method can also be used to determine iron, manganese, or other metal concentration in any liquid hydrocarbonaceous matrix. The principles, demonstrated herein, of transporting organic manganese from an organic to an inorganic phase to facilitate detection and quantification by a method developed for aqueous inorganic media can be extended to other metallic elements existing as organometallics in organic media. Examples of such elements in addition to Mn are Cr, Fe, Co, Cu, Zr, Mo, Ru, Rh, Pd, La, Hf, Re, Os, Ir, Pt, Au, Hg, Ce, and other transition metals, lanthanides and actinides that form colored inorganic compounds in the aqueous media. The organo portion of the organometallic compound detectable herein can be any chelate, complex, coordination group, sandwich molecule, solubilizing agent, carrier, salt, crown ether, cryptands, aza-crown ether, spherands, and the like. Thus, for example, the sandwich-like structure of ferrocene and MMT illustrate certain embodiments of the organo portion of the organometallic compound detectable herein.

In another embodiment provided herein is a device, system or kit comprising materials and reagents useful in performing the methods of detection taught herein. Thus another example includes a collection, combination or assembly of some or all of the materials described herein above. Yet another example includes (a) at least one colorimetric detection strip with organic ligands able to bind to or bond with certain metal ions to form an organometallic complex and also containing at least one colorimetric indicator chemical, (b) a source or supply of dilute basic solution, such as NaOH, (c) a source or supply of dilute acidic solution, such as acetic acid, (d) optionally an ultraviolet radiation source, and (e) a colorimetric photometer able to detect organometallic complex concentration as a function of color intensity. The UV source useful herein can include, for example, the sun, fluorescent lamps, incandescent lamps, UV irradiation lamps, and other devices able to emit radiation in the wavelength of ultraviolet radiation.

Advantages of this invention include but are not limited to 1) facilitating a rapid spot check of metal additive concentrations in commercial hydrocarbonaceous fuels in the field, 2) simple to operate, requiring little expertise, and 3) it is readily portable.

Other embodiments of the present invention will be apparent to those skilled in the art from consideration of the specification and practice of the invention disclosed herein. As used throughout the specification and claims, “a” and/or “an” may refer to one or more than one. Unless otherwise indicated, all numbers expressing quantities of ingredients, properties such as molecular weight, percent, ratio, reaction conditions, and so forth used in the specification and claims are to be understood as being modified in all instances by the term “about.” Accordingly, unless indicated to the contrary, the numerical parameters set forth in the specification and claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. It is intended that the specification and examples be considered as exemplary only, with a true scope and spirit of the invention being indicated by the following claims.

1. A method for detecting the presence of a metallic species in a hydrocarbon matrix, comprising (a) contacting a hydrocarbon matrix containing an organometallic compound with a colorimetric detection material comprising a colorimetric sensitizer chemical able to react with the metal of the organometallic compound; (b) causing a reaction between the metal from the organometallic compound and the colorimetric sensitizer chemical sufficient to form an organometallic complex, and (c) detecting the presence of the organometallic complex.

2. The method of claim 1, wherein the detection material is exposed to sufficient energy to at least partially liberate the metal of the organometallic compound from the compound onto or within the detection material.

3. The method of claim 2, wherein the energy is in the form of heat.

4. The method of claim 2, wherein the energy is in the form of sonic radiation.

5. The method of claim 2, wherein the energy is from a chemical reaction due to a chemical added.

6. The method of claim 2, wherein the energy is in the form of ultraviolet radiation.

7. The method of claim 2, wherein the energy is in the form of sunlight.

8. The method of claim 2, wherein the energy is radiation of a wavelength and intensity (measured in joules/mole) absorbed by the organometallic compound sufficient to decompose said compound.

9. The method of claim 1, wherein the hydrocarbon matrix is selected from the group consisting of gasolines, petroleum distillate fuels, kerosene, diesel fuel, biodiesel fuel, fuel oil, crude oil, refined oil, lubricants, engine oils, transmission fluids, hydraulic oils, aviation fuels, cutting fluids, and distillate bottoms.

10. The method of claim 1, wherein the hydrocarbon matrix is gasoline.

11. The method of claim 1, wherein the hydrocarbon matrix is diesel fuel.

12. The method of claim 1, wherein the metal of the organometallic compound is selected from the group consisting of Mn, Cr, Fe, Co, Cu, Zr, Mo, Ru, Rh, Pd, La, Hf, Re, Os, Ir, Pt, Au, Hg, Ce, lanthanides, and actinides.

13. The method of claim 1, wherein the presence of the organometallic complex is detected by a photometer.

14. The method of claim 1, further comprising the step of combining the detection material from step (b) with an amount of dilute basic solution to the at least partially liberated metal of the organometallic compound.

15. The method of claim 14, further comprising the step of combining the basified metal with a dilute acid to oxidize the metal to an oxidation state able to react with the colorimetric sensitizer chemical.

16. The method of claim 1, wherein the concentration of the organometallic compound in the hydrocarbon matrix is determined by translating the calorimetrically detected color intensity of the organometallic complex into a metal concentration value.

17. The method of claim 1, wherein the metal of the organometallic compound is manganese.

18. The method of claim 16, wherein the organometallic compound is methyl cyclopentadienyl manganese tricarbonyl.

19. The method of claim 1, wherein the hydrocarbon matrix is selected from the group consisting of gasolines, diesel fuels, biodiesel fuels, fuel oil, industrial hydrocarbonaceous waste, and distillate fuels.

20. A detection system for detecting the presence of metal in a hydrocarbon matrix, said detection comprising a colorimetric detection material comprising at least one colorimetric sensitizer chemical able to react with a metal of an organometallic compound in the hydrocarbon matrix.

21. The detection system of claim 19, further comprising a source of radiation sufficient to liberate the metal in the organometallic compound from the compound.

22. The detection system of claim 19, further comprising a means for calorimetrically detecting the presence of a metal.

23. The detection system of claim 19, further comprising one or more reagents effective in combining the metal from the organometallic compound with the at least one colorimetric sensitizer chemical.
